(19) United States
(12) Patent Application Publication
(10) Pub. No.: US 2011/0068601 A1
(43) Pub. Date: Mar. 24, 2011

(54) Vehicle Solar Load Reduction System

(75) Inventors: David M. Connor, Grand Blanc, MI (US); Joseph M. Polewarczyk, Rochester Hills, MI (US)

(73) Assignee: GM GLOBAL TECHNOLOGY OPERATIONS, INC., Detroit, MI (US)

(21) Appl. No.: 12/565,025

(22) Filed: Sep. 23, 2009

(51) Int. Cl. B60J 1/20

(52) U.S. Cl. 296/152; 296/97.5

(57) ABSTRACT

A vehicle having a vehicle interior may comprise a backlight having an interior surface and a solar load reduction system. The solar load reduction system may include a louver support supported by the vehicle structure, a plurality of pivotable louvers located in the vehicle interior, each of the louvers may be pivotally mounted to the louver support and spaced from the other louvers, and a tilting mechanism adjacent to the backlight and operatively engaging the plurality of louvers to selectively cause the louvers to pivot relative to the louver support. A pane of translucent material may enclose the louvers in a cavity between the pane and backlight.

### BACKGROUND OF INVENTION

The present invention relates generally to a solar load reduction device and more particularly to louvers mounted inside a vehicle backlight.

A significant emphasis is being placed on improving the fuel economy of automotive vehicles while maintaining or improving passenger comfort. One area in particular where fuel economy and passenger comfort can be adversely affected is with the solar load on the interior of a vehicle due to sun light shining through the vehicle windows. This solar load increases the load on the air conditioning system when cooling the vehicle interior. One window in particular, the vehicle backlight, can contribute significantly to the solar load on a vehicle parked in the sun.

Some have attempted to reduce this solar load through the use of thin, horizontally extending louvers fixed adjacent to the inside or outside of the backlight. Being fixed horizontally, the thin louvers still allow a vehicle operator to see out of the back window, while the horizontal width of each louver will reflect some of the solar load, thus reducing the heat load on the vehicle interior. However, for externally mounted louvers, the aerodynamics of the vehicle may be adversely affected. Moreover, for both interior and exterior mounted louvers, the solar load is only partially reduced, especially when the sun is not directly overhead.

### SUMMARY OF INVENTION

An embodiment contemplates a vehicle having a vehicle structure defining a vehicle interior comprising a backlight supported by the vehicle structure and having an interior surface facing into the vehicle interior, and a solar load reduction system. The solar load reduction system may include a louver support supported by the vehicle structure, a plurality of pivotable louvers located in the vehicle interior adjacent to the interior surface, with each of the louvers pivotally mounted to the louver support and spaced from the other louvers, and a tilting mechanism adjacent to the backlight and operatively engaging the plurality of louvers to selectively cause the louvers to pivot relative to the louver support, whereby the louvers can be rotated between an open position allowing for a horizontal view through the louvers and the backlight and a closed position where the horizontal view through the louvers is blocked.

An embodiment contemplates a vehicle, having a vehicle structure defining a vehicle interior, comprising a backlight supported by the vehicle structure and having an interior surface facing into the vehicle interior, and a solar load reduction system. The solar load reduction system may include a louver support supported by the vehicle structure, a plurality of louvers located in the vehicle interior adjacent to the interior surface, with each of the louvers mounted to the louver support and spaced from the other louvers and oriented to allow for a horizontal view through the louvers, and an interior pane of translucent material supported by the vehicle structure in the vehicle interior, spaced from the backlight and adjacent to the plurality of louvers to thereby form a cavity within which the plurality of louvers are located.

An advantage of an embodiment is that the solar load transmitted through the backlight into the vehicle is reduced, which lowers the energy required to cool the vehicle interior to an acceptable temperature for occupants and other vehicle components that may require temperature management (such as a battery pack for a hybrid or electric vehicle). This reduced solar load is accomplished with minimal power consumed, minimal increase in vehicle mass and without increasing the aerodynamic drag of the vehicle.

### BRIEF DESCRIPTION OF DRAWINGS

FIG. 1 is a schematic, block diagram of a vehicle solar load reduction system.

FIG. 2 is a schematic, perspective view of a portion of an exterior of a vehicle having the vehicle solar load reduction system.

FIG. 3 is a schematic, sectional view of a portion of the vehicle, with the solar load reduction system in the open position.

FIG. 4 is a schematic view similar to FIG. 3, but with an added interior pane and the solar load reduction system in a partially closed position.

### DETAILED DESCRIPTION

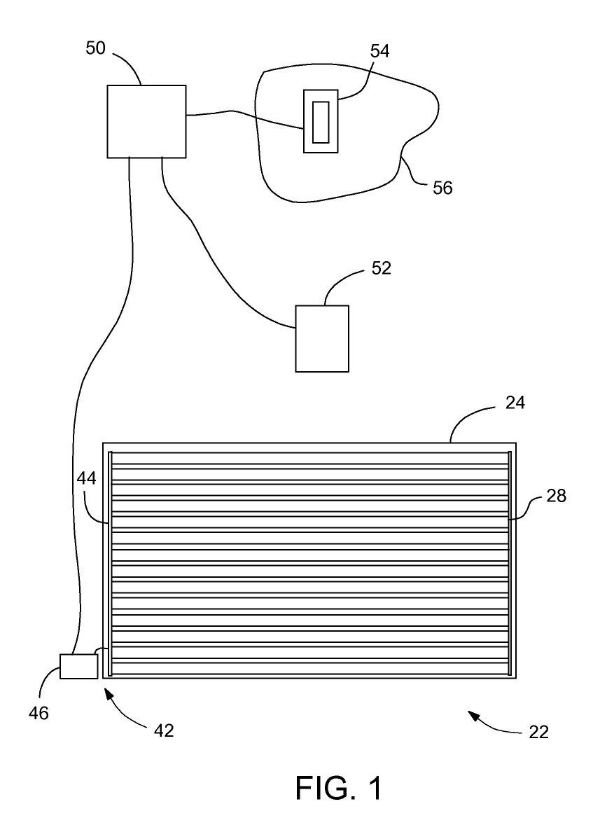

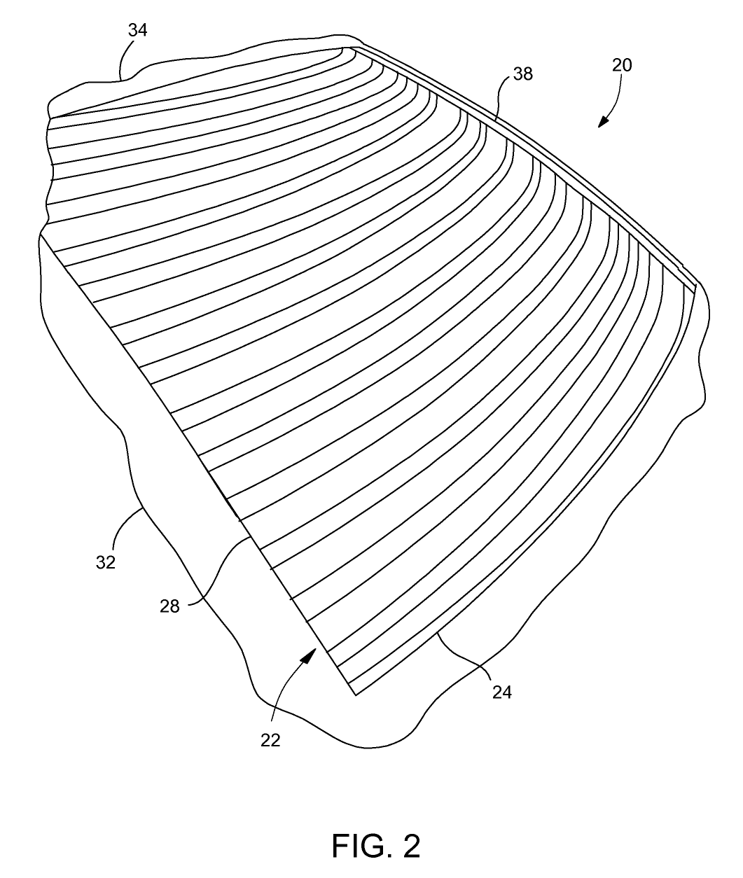

FIGS. 1-3 illustrate portions of a vehicle, indicated generally at 20, that includes a solar load reduction system 22. The system 22 is adjacent to a backlight 24 (that is, the back window of the vehicle) in the vehicle interior 26. The system 22 includes a set of pivotable louvers 28 adjacent to an interior surface 30 of the backlight 24 that extend side-to-side essentially between the two rear roof pillars 32 and are spaced essentially from the vehicle roof 34 to a rear panel 36 of the vehicle 20, such as a rear package shelf in a sedan—although, the pivotable louvers 28 may be employed with other styles of vehicles as well.

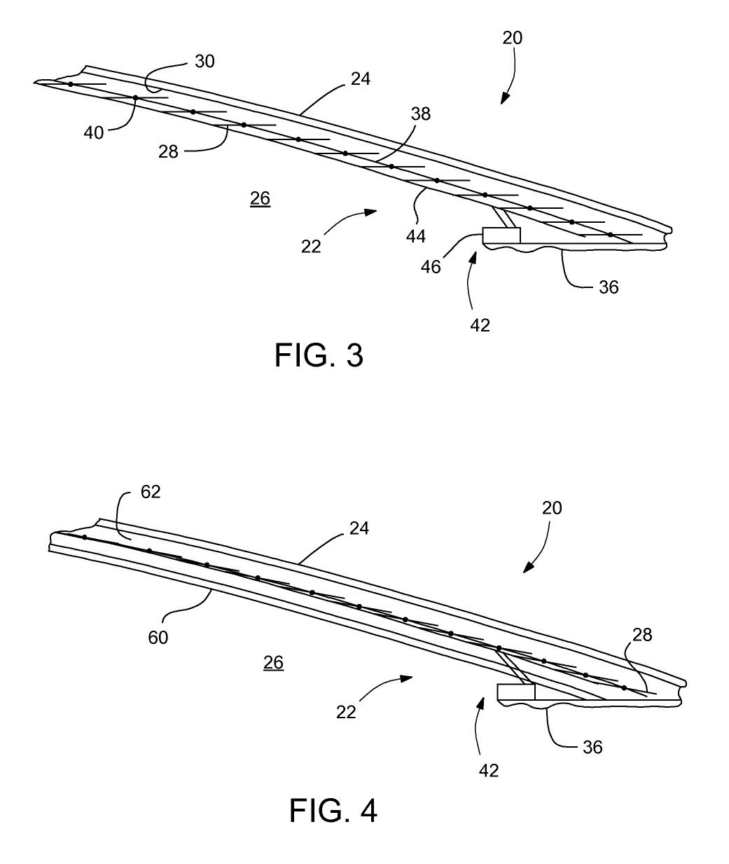

Each of the louvers 28 is long and slender, extending horizontally from side-to-side, generally following the curvature of the interior surface 30 of the backlight 24. A pair of louver supports 38 mount at their lower ends to structure such as the rear panel 36 and at their upper ends to structure such as the roof 34. The louver supports 38 mount to each louver 28 at pivot joints 40 that support the louvers 28 in spaced relation to each other and allow for pivoting of the louvers 28 relative to the louver supports 38. The thickness of each louver 28 is preferably small, just enough to maintain the desired stiffness of each louver, in order to minimize the loss in visual field (in a horizontal direction) through the backlight 24 when the louvers 28 are in the open position (see FIG. 3 for louvers shown in the open position). The width of each louver 28 is preferably just sufficient so that the louvers overlap somewhat when in the closed position (see FIG. 4 for louvers shown in the partially closed position) in order to block most if not all of the solar load entering though the backlight 24. They may be somewhat thicker or wider for esthetic reasons or to obtain better solar load blockage when the louvers 28 are in the open position, but the tradeoff is that this will add more weight to the vehicle 20. Each of the louvers 28 may be covered with an infrared reflective coating to better reflect the solar load back out of the vehicle 20 through the backlight 24. Such a coating may be, for example, a polished metal, a mirror coating or some other type of coating that reflects the solar load back out of the vehicle 20. Alternatively, each of the louvers 28 may be covered with solar cells to provide power for actuation of the louvers 28 in a self-powered system.

The solar load reduction system 22 also includes a tilting mechanism 42 that may include, for example, a tilting arm 44 that connects to each of the louvers 28 at locations spaced from the pivot joints, and a motor assembly 46 that is connected to and drives the tilting arm 44. As the motor assembly 46 is driven in one direction, the tilting arm 44 will cause each of the louvers 28 to pivot toward a closed position where the louvers lay on top of each other to fully reflect the solar load coming in through the backlight 24. As the motor assembly 46 is driven in the other direction, the tilting arm 44 will cause each of the louvers 28 to pivot to a generally horizontal position (the open position) where the blockage of the driver's view horizontally through the backlight 24 is minimized while still allowing for reflection of some of the solar load when the sun is more overhead in the sky (i.e., block sun light directed in a more vertical direction). Other types of tilting mechanisms may be employed instead, if so desired. Thus, when referring to a “motor assembly” herein, this includes other types of actuators that can be used to tilt the louvers back and forth.

The solar load reduction system 22 may also include a controller 50 that controls the operation of the motor assembly 46, and either or both of a solar load sensor 52 and a louver switch 54, which may be mounted on an instrument panel 56. The controller may be a stand alone device or may be part of a larger controller, such as a body control module or powertrain control module. The solar load sensor 52 may be mounted, for example, on the instrument panel 56 or the rear panel 36 in the vehicle interior 26. If equipped with a solar load sensor 52, the controller 50 may detect when the vehicle has been shut off for a predetermined time, for example, and if the solar load indicated by the solar load sensor 52 is above a predetermined threshold, activate the motor assembly 46 to tilt the louvers 28 to the closed position, thus minimizing the solar load entering the vehicle interior 26 through the backlight 24.

In addition, the louver switch 54 may be actuated by a vehicle occupant to activate the motor assembly 46 to tilt the louvers 28 to the closed position even if the solar load sensor 52 does not detect a high level of solar load. In this case, the switch 54 may be a three position switch, with one position that allows the controller 50, with input from the solar load sensor 52 (among other sensors), to determine the appropriate position for the louvers 28, a second position to override the solar load sensor 52 to cause the louvers 28 to open and stay opened and a third position to cause the louvers 28 to close and stay closed. Alternatively, if the louver switch 54 is connected to the motor assembly 46 via the controller 50, then the controller 50 may be optionally programmed to prevent louver closure while the vehicle 20 is running, even if the louver switch 54 is actuated to the louver closed position.

Alternatively, there may be no solar load sensor in the vehicle 20, and the louver switch 54 may be connected directly to the motor assembly 46 and pivot the louvers 28 to the opened or closed position based solely on the position the vehicle occupant places the louver switch 54. In this case, the louver switch 54 may be a two position switch. In another alternative, there may be no louver switch 54 and the position of the louvers 28 is then determined by the controller 50 based on the solar load sensor 52 and the state of other vehicle parameters.

FIG. 4 illustrates a schematic, sectional view of a portion of the vehicle 20, with the solar load reduction system 22 in a partially closed position, and with the addition of an optional interior pane 60 of translucent material. The interior pane 60 is mounted in the vehicle interior 26 and generally parallels the backlight 24. This forms a cavity 62 between the backlight 24 and the interior pane 60 within which are mounted the louvers 28. The louvers 28 may still be pivotable by a tilting mechanism 42, if so desired, to allow for improved solar load reduction control. In this instance, the interior pane 60 allows for pivoting of the louvers 28 while preventing a object (not shown) sitting on the rear panel 36 (such as a package shelf) from interfering with the pivoting motion. The interior pane 60 also blocks any objects from striking and breaking the louvers 28.

While certain embodiments of the present invention have been described in detail, those familiar with the art to which this invention relates will recognize various alternative designs and embodiments for practicing the invention as defined by the following claims.

What is claimed is:

1. A vehicle having a vehicle structure defining a vehicle interior comprising:
a backlight supported by the vehicle structure and having an interior surface facing into the vehicle interior; and
a solar load reduction system including a louver support supported by the vehicle structure, a plurality of pivotable louvers located in the vehicle interior adjacent to the interior surface, each of the louvers pivotally mounted to the louver support and spaced from the other louvers, and a tilting mechanism adjacent to the backlight and operatively engaging the plurality of louvers to selectively cause the louvers to pivot relative to the louver support, whereby the louvers can be rotated between an open position allowing for a horizontal view through the louvers and the backlight and a closed position where the horizontal view through the louvers is blocked.

2. The vehicle of claim 1 including an interior pane of translucent material supported the vehicle structure in the vehicle interior, spaced from the backlight and adjacent to the plurality of pivotable louvers to thereby form a cavity within which the plurality of pivotable louvers are located.

3. The vehicle of claim 1 wherein each of the louvers is coated with an infrared reflective coating.

4. The vehicle of claim 1 including a controller operatively engaging the tilting mechanism to cause the tilting mechanism to move the louvers between the open position and the closed position.

5. The vehicle of claim 4 including a solar load sensor in communication with the controller, wherein the controller is configured to use an input from the solar load sensor as a factor in determining when to cause the tilting mechanism to move the louvers between the open position and the closed position.

6. The vehicle of claim 5 including a louver switch in communication with the controller, wherein the controller is configured to cause the tilting mechanism to override the input from the solar load sensor and move the louvers between the open position and the closed position based on a position of the louver switch.

7. The vehicle of claim 4 including a louver switch in communication with the controller, wherein the controller is configured to cause the tilting mechanism to move the louvers between the open position and the closed position based on a position of the louver switch.

8. The vehicle of claim 1 including a louver switch in communication with the tilting mechanism, wherein the switch is configured to include a first position that causes the tilting mechanism to move the louvers to the open position and a second position that causes the tilting mechanism to move the louvers to the closed position.

9. The vehicle of claim 1 wherein the tilting mechanism includes a tilting arm connected to each of the louvers spaced from the louver support and a motor assembly operatively engaging the tilting arm to cause the louvers to pivot relative to the louver support.

10. The vehicle of claim 1 wherein the solar load reduction system includes a second louver support, spaced from the first louver support and supported by the vehicle structure, each of the louvers pivotally mounted to the second louver support.

11. A vehicle having a vehicle structure defining a vehicle interior comprising:
a backlight supported by the vehicle structure and having an interior surface facing into the vehicle interior; and
a solar load reduction system including a louver support supported by the vehicle structure, a plurality of louvers located in the vehicle interior adjacent to the interior surface, each of the louvers mounted to the louver support and spaced from the other louvers and oriented to allow for a horizontal view through the louvers, and an interior pane of translucent material supported by the vehicle structure in the vehicle interior, spaced from the backlight and adjacent to the plurality of louvers to thereby form a cavity within which the plurality of louvers are located.

12. The vehicle of claim 11 wherein the solar load reduction system includes a tilting mechanism adjacent to the backlight and operatively engaging the plurality of louvers to selectively cause the louvers to pivot relative to the louver support, whereby the louvers can be rotated between an open position allowing for the horizontal view through the louvers and the backlight and a closed position where the horizontal view through the louvers is blocked.

13. The vehicle of claim 12 including a controller operatively engaging the tilting mechanism to cause the tilting mechanism to move the louvers between the open position and the closed position. The vehicle of claim 11 wherein each of the louvers is coated with an infrared reflective coating.

14. The vehicle of claim 13 including a solar load sensor in communication with the controller, wherein the controller is configured to use an input from the solar load sensor as a factor in determining when to cause the tilting mechanism to move the louvers between the open position and the closed position.

15. The vehicle of claim 14 including a louver switch in communication with the controller, wherein the controller is configured to cause the tilting mechanism to override the input from the solar load sensor and move the louvers between the open position and the closed position based on a position of the louver switch.

16. The vehicle of claim 13 including a louver switch in communication with the controller, wherein the controller is configured to cause the tilting mechanism to move the louvers between the open position and the closed position based on a position of the louver switch.

17. The vehicle of claim 12 including a louver switch in communication with the tilting mechanism, wherein the switch is configured to include a first position that causes the tilting mechanism to move the louvers to the open position and a second position that causes the tilting mechanism to move the louvers to the closed position.

18. The vehicle of claim 11 wherein each of the louvers is coated with an infrared reflective coating.
